(19) United States
(12) Patent Application Publication
(10) Pub. No.: US 2022/0312758 A1
(43) Pub. Date: Oct. 6, 2022

(54) STRUCTURAL ELEMENT, IN PARTICULAR PANE ELEMENT, HAVING PROTECTION AGAINST BIRD STRIKE AND A PROCESS FOR PRODUCING SUCH A STRUCTURAL ELEMENT

(71) Applicant: BirdShades Innovations GmbH, Leoben (AT)

(72) Inventors: Bettina Maria KAIN, Dellach im Drautal (AT); Dominique May WADDOUP, Graz (AT)

(73) Assignee: BirdShades Innovations GmbH, Leoben (AT)

(21) Appl. No.: 17/608,757

(22) PCT Filed: May 5, 2020
(86) PCT No.: PCT/EP2020/062437

§ 371 Date: Nov. 4, 2021

(30) Foreign Application Priority Data
May 6, 2019 (AT) A50406/2019

(51) Int. Cl. A01M 29/08

(52) U.S. Cl. CPC A01M 29/08

(57) ABSTRACT

The present invention relates to a structural element, in particular a pane element, having protection against bird strike and comprising a transparent base body, in particular made of glass and/or a transparent plastic material, wherein the transparent base body is at least partly covered with a component absorbing UVA light, at least partly covered with a fluorescent component and at least partly covered with a component reflecting UVA light. In addition, the present invention relates to process for producing such a structural element.

### FIELD OF THE INVENTION

The present invention relates to a structural element, in particular a pane element, having protection against bird strike and a process for producing such a structural element.

### BACKGROUND

Bird strike (or bird impact) at glass planes or other transparent structural elements represents the second most common cause of death of birds caused by humans, right after the loss of habitat for birds caused by humans. Each year, approximately almost one billion birds die because of bird strike at glass planes in the US alone. In addition to visible light (400-700 nm), light within the UVA range of 320-400 nm may also pass through glass planes which are therefore not visible for birds.

In this connection, the transparency of glass planes poses a problem because the birds may see and approach the environment behind the panes but may not recognize the glass barrier. Also the mirroring of glass planes represents a problem because the environment is mirrored and the bird may not identify it as a mirroring, but approaches.

In contrast to humans, many bird species are capable of perceiving electromagnetic radiation in at least part of the UVA range (approximately 320-400 nm). It is assumed that this is because of so-called UVS receptors widely spread in the order Passeriformes, such as passerine birds (passeridae), the largest order in the class of birds as well as the order most suffering from bird strike.

The difference to humans in the perception of UVA light provides an approach to avoid bird strike at glass planes or other transparent structural elements. For example, the optical properties (such as the transparency) of glass surfaces may be modified for UVA light so that they become perceptible to birds without compromising their transparency to the human eye. Previous attempts based on this approach have been described for instance in WO 2017/079822 A1, AT 511 998 A1, US 2007/0190343 A1, US 2015/0050505 A1, EP 1 110 450 A2 and WO 2015/181542 A1, wherein UVA light is absorbed, reflected or also emitted again (fluorescence).

However, there may still be a need for improvements in the prevention of bird strikes, in particular in terms of efficiency, ease of use, weather resistance or environmental compatibility. Especially in terms of efficiency, i.e. the degree of avoidance of bird strikes, previous “bird protection glasses” have not yet met expectations.

### OBJECT OF THE INVENTION

Thus, an object of the present invention is to provide a structural element, such as a pane or another structural element transparent to the human eye, which provides efficient protection against bird strike without losing its (desired) transparency to the human eye, is easily applicable or can be easily produced, is well weather-resistant and/or as environmentally friendly as possible.

### SUMMARY OF THE INVENTION

The inventors of the present invention have carried out extensive studies for solving these objects and have in particular found that by a combination of UVA light-absorbing, fluorescent and UVA light-reflecting components applied to a transparent base body, made of glass and/or a transparent plastic material, the perceptibility of the structural element to birds can be significantly increased. In particular, by a suitable arrangement of the UVA light-absorbing, fluorescent and UVA light-reflecting components, for example partially side by side or also partially overlapping, or also in a certain pattern, the contrast between the various components can be increased, so that it becomes better and—also while flying—faster recognizable for birds that they cannot fly further here.

Accordingly, the present invention relates to a structural element, in particular a pane element, having a transparent base body, in particular made of glass and/or a transparent plastic material, wherein the transparent base body is at least partly covered with a component absorbing UVA light, at least partly covered with a fluorescent component and at least partly covered with a component reflecting UVA light (so that the structural element is perceptible to birds, but is or remains substantially transparent for humans).

In addition, the present invention relates to a process for producing a structural element, in particular a structural element according to the invention as described herein, wherein the process comprises the following steps:
providing a transparent base body, in particular made of glass and/or a transparent plastic material,
applying a component absorbing UVA light on at least a part of a surface of the transparent base body,
applying a fluorescent component on at least a part of a surface of the transparent base body,
applying a component reflecting UVA light on at least a part of a surface of the transparent base body.

Other objects and many of the attendant advantages of embodiments of the present invention will be readily appreciated and become better understood by reference to the following detailed description of embodiments and the accompanying drawings.

### BRIEF DESCRIPTION OF THE DRAWINGS

FIG. 1 shows lateral cross-sectional views of structural elements according to various embodiments of the invention.

FIG. 2 shows plan views of structural elements according to various embodiments of the invention.

FIG. 3 shows emission spectra of an optical brightener in the presence or absence of tryptophan.

FIG. 4 shows results of a reflection determination of an optical brightener without prime coats and with different prime coats.

### DETAILED DESCRIPTION OF THE INVENTION

Hereinafter, details of the present invention and further embodiments thereof will be described. However, the present invention is not limited to the following specific descriptions, but they are rather only for illustrative purposes of the inventive teachings.

It should be noted that features described in connection with one exemplary embodiment or exemplary aspect may be combined with any other exemplary embodiment or exemplary aspect. In particular, features described in connection with any exemplary embodiment of a structural element may be combined with any other exemplary embodiment of a structural element as well as with any exemplary embodiment of a process and vice versa, unless specifically stated otherwise.

Where an indefinite or definite article is used when referring to a singular term, such as “a”, “an” or “the”, a plural of that term is also included and vice versa, unless the context clearly dictates otherwise. The expression “comprising”, as used herein, includes not only the meaning of “comprising”, “including” or “containing”, but also encompasses “consisting essentially of” and “consisting of”.

Unless specifically stated otherwise, the expression “at least a part of” or “at least partly”, as used herein, may mean at least 5% thereof, in particular at least 10% thereof, in particular at least 15% thereof, in particular at least 20% thereof, in particular at least 25% thereof, in particular at least 30% thereof, in particular at least 35% thereof, in particular at least 40% thereof, in particular at least 45% thereof, in particular at least 50% thereof, in particular at least 55% thereof, in particular at least 60% thereof, in particular at least 65% thereof, in particular at least 70% thereof, in particular at least 75% thereof, in particular at least 80% thereof, in particular at least 85% thereof, in particular at least 90% thereof, in particular at least 95% thereof, in particular at least 98% thereof, and may also mean 100% thereof.

The structural element according to the invention comprises a transparent base body that is at least partly covered with a component absorbing UVA light, at least partly covered with a fluorescent component and at least partly covered with a component reflecting UVA light.

In the context of the present application, the term “structural element”, which may also be referred to as a “building element” or a “building unit”, may in particular denote a part or a component of a building or another construction. In addition, a structural element within the meaning of the present invention is preferably substantially transparent to the human eye. The structural element may in particular be a pane element, as it is used in a window or also in a door. However, the structural element may also be a building block, such as glass blocks or building blocks made from transparent plastics, that are integrated in a wall or a ceiling or at least partly form the same and provide for a certain translucence of the wall or the ceiling (for instance as a roof light).

In the context of the present application, the term “pane element”, which may also be referred to as a “window element”, may in particular denote a planar construction, for instance made of glass or a transparent plastic material, such as a flat glass or plate glass that may be contained or integrated in a window, a door or another opening.

The term “transparent”, as used herein, may mean that the thus characterized object may be substantially transparent or translucent for visible light (e.g. having a wavelength of from 400 to 700 nm) and preferably also for light within the UVA range of from 320 to 400 nm.

The transparent base body may in particular be made of glass and/or a transparent plastic material. The transparent base body may for instance be composed of one or more layers or glass panes, for instance a laminated or multilayer glass having a plastic foil, resin or gas between the individual panes.

In the context of the present application, the term “UVA light” may in particular denote electromagnetic radiation having a wavelength in a range of from 320 to 400 nm.

In the context of the present application, a “component absorbing UVA light” may in particular denote a component (such as a chemical compound or a chemical element or a mixture of chemical compounds and/or elements) that is capable or configured to absorb electromagnetic radiation having a wavelength in a range of from 320 to 400 nm. In this connection, the component absorbing UVA light does not necessarily have to absorb electromagnetic radiation across the entire wavelength range of from 320 to 400 nm, but it may be sufficient if the component may absorb electromagnetic radiation at least within a portion of the wavelength range of from 320 to 400 nm. In particular, it may be advantageous if the component absorbing UVA light exhibits only a relatively low light absorbency at 400 nm or above in order that it may not or hardly be perceived by the human eye and thus does not significantly (or not at all) impair the transparency of a respective structural element to the human eye. Nevertheless, it may be possible that the component absorbing UVA light may exhibit a certain light absorbency also in the wavelength range of visible light, for instance up to a wavelength of about 450 nm.

In the context of the present application, a “fluorescent component” may in particular denote a component (such as a chemical compound or a chemical element or a mixture of chemical compounds and/or elements) that is capable or configured to absorb electromagnetic radiation having a wavelength in a range of from about 200 nm to 450 nm and to emit electromagnetic radiation typically having a higher wavelength (owing to a Stokes shift) for instance in a range of from about 300 nm to 500 nm. In this connection, the fluorescent component does not necessarily have to absorb electromagnetic radiation across the entire above-mentioned wavelength range or to emit electromagnetic radiation across the entire above-mentioned wavelength range, but it may be sufficient if the component may absorb and/or emit electromagnetic radiation at least within a portion of the above-mentioned wavelength ranges. In particular, it may be advantageous if the fluorescent component exhibits only a relatively low light absorbency and/or emissivity at 400 nm or above in order that it may not or hardly be perceived by the human eye and thus does not significantly (or not at all) affect the appearance of a respective structural element to the human eye.

In the context of the present application, a “component reflecting UVA light” may in particular denote a component (such as a chemical compound or a chemical element or a mixture of chemical compounds and/or elements, but also a (three-dimensional) structure) that is capable or configured to reflect electromagnetic radiation having a wavelength in a range of from 320 to 400 nm. In this connection, the component reflecting UVA light does not necessarily have to reflect electromagnetic radiation across the entire wavelength range of from 320 to 400 nm, but it may be sufficient if the component may reflect electromagnetic radiation at least within a portion of the wavelength range of from 320 to 400 nm. In particular, it may be advantageous if the component reflecting UVA light exhibits only a relatively low reflectivity (reflectance) at 400 nm or above in order that it may not or hardly be perceived by the human eye and thus does not significantly (or not at all) affect the appearance of a respective structural element to the human eye. Nevertheless, it may be possible that the component reflecting UVA light may exhibit a certain reflectivity also in the wavelength range of visible light, for instance up to a wavelength of about 450 nm.

In an exemplary embodiment, a surface of the transparent base body is at least partly covered with a component absorbing UVA light, at least partly covered with a fluorescent component and at least partly covered with a component reflecting UVA light. In other words, the component absorbing UVA light, the fluorescent component as well as the component reflecting UVA light may be arranged at or on the same surface or at one side of the transparent base body, for instance at an exterior (i.e. facing the environment) side or surface of the transparent base body when in use or at an internal (i.e. facing the interior of a building) side or surface of the transparent base body when in use. This may be advantageous for instance in that several components may be efficiently applied by the same application technique, for instance in the form of a foil or a varnish.

Alternatively, the component absorbing UVA light, the fluorescent component and the component reflecting UVA light may be arranged at or on opposing surfaces or sides of the transparent base body, for instance some of the component absorbing UVA light, the fluorescent component and the component reflecting UVA light may be arranged at an internal (i.e. facing the interior of a building) side or surface of the transparent base body when in use and some of the component absorbing UVA light, the fluorescent component and the component reflecting UVA light may be arranged at an exterior (i.e. facing the environment) side or surface of the transparent base body when in use. This may be advantageous for instance if different application techniques are used for the different components which may otherwise (negatively) interfere with each other. Moreover, due to the thickness of the transparent base body, additional optical effects, for instance 3D effects such as an angle-dependent tilting effect, may occur, which further improve the perceptibility of the structural element for birds when the components are applied at different levels.

In an exemplary embodiment, the component absorbing UVA light is arranged in a UVA light-absorbing area, the fluorescent component is arranged in a fluorescent area and the component reflecting UVA light is arranged in a UVA light-reflecting area. That is, the area on the transparent base body, that is covered with a component absorbing UVA light, is hereinafter also referred to as “UVA light-absorbing area”, the area on the transparent base body, that is covered with a fluorescent component, is hereinafter also referred to as “fluorescent area”, and the area on the transparent base body, that is covered with a component reflecting UVA light, is hereinafter also referred to as “UVA light-reflecting area”. Of course, each area, i.e. the UVA light-absorbing area, the fluorescent area as well as the UVA light-reflecting area may be present several times on the transparent base body. In addition, there may be one or more “transparent areas” on the transparent base body, which may in particular denote surface areas of the transparent base body, that are covered neither with a component absorbing UVA light, nor with a fluorescent component nor with a component reflecting UVA light. A transparent area may however also be formed by transparent components, such as polyimide, polyurethanes, polyethylene, polyethylene terephthalate, polycarbonate, polypropylene, biopolymers (e.g. polylactide, cellulose acetate) and/or silicon. Transparent varnishes, such as a polyurethane varnish and/or an epoxy varnish, may be also suitable for forming a transparent area.

In an exemplary embodiment, at least two, in particular all three, of the UVA light-absorbing area, the fluorescent area and the UVA light-reflecting area are arranged side by side. In particular, the areas may be arranged directly adjacent to each other and/or spaced apart from each other, for instance spaced apart from each other by a transparent area. By taking this measure, it may be possible to generate particularly high-contrast patterns on the transparent base body which may thus be particularly well perceptible to birds.

In an exemplary embodiment, at least two, in particular all three, of the UVA light-absorbing area, the fluorescent area and the UVA light-reflecting area at least partly overlap or superpose. For instance, the UVA light-absorbing area and the fluorescent area may at least partly overlap. It may be possible that the UVA light-absorbing area and the UVA light-reflecting area at least partly overlap. It may be also possible that the fluorescent area and the UVA light-reflecting area at least partly overlap. It may be also possible that the UVA light-absorbing area, the fluorescent area as well as the UVA light-reflecting area at least partly overlap. By a partial overlap of the areas and thus by a partial superposition of a component absorbing UVA light, a fluorescent component and/or a component reflecting UVA light, additional optical effects may be achieved further improving the perceptibility of the structural element for birds. It may even be possible to achieve synergistic effects by a combination of different components.

In an exemplary embodiment, the component absorbing UVA light is an organic compound capable of absorbing UVA light and having conjugated double bonds (in particular conjugated n systems).

In an exemplary embodiment, the component absorbing UVA light is selected from the group consisting of aromatic CH-acidic diketones, aromatic ketones, 6,7-dihydroxycoumarins, polyphenols, flavonoids, inorganic microparticles (fine-grained inorganic substances) and mixtures, blends or combinations thereof. These classes of substances have proven to be suitable components absorbing UVA light according to the invention. In the context of the present application, the terms “microparticles” or “fine-grained substances” may in particular denote particles having an average particle size in the range of from 1 nm to 10 μm, in particular from 10 nm to 5 μm.

In particular, the component absorbing UVA light may be selected from the group consisting of avobenzone, benzophenone, aesculin, quercetin, rutin and mixtures, blends or combinations thereof. These substances have proven to be particularly suitable components absorbing UVA light according to the invention. For instance, aesculin—a glucoside belonging to the class of substances of 6,7-dihydroxycoumarins—has a particularly advantageous absorption spectrum having a maximum in the UVA range and transparency in the visible light for the human eye. But also avobenzone belonging to the class of substances of aromatic CH-acidic diketones and having an absorption maximum at 357 nm, benzophenone belonging to the class of substances of aromatic ketones as well as quercetin and its glycoside rutin belonging to the class of substances of polyphenols and flavonoids have proven to be promising candidates for the component absorbing UVA light.

In an exemplary embodiment, the fluorescent component is an organic compound capable of emitting UVA light and having conjugated double bonds (in particular conjugated n systems).

In an exemplary embodiment, the fluorescent component is selected from the group consisting of optical brighteners, in particular stilbenes, polyphenols, flavonoids, inorganic fluorescent compounds and mixtures, blends or combinations thereof. In the context of the present application, the term “optical brighteners” may in particular denote fluorescent components capable of absorbing electromagnetic radiation in the UVA range (for instance in the range of from 320 to 400 nm) and of emitting fluorescence radiation in the short-wave visible spectrum (for instance up to 450 nm). In particular stilbenes belong to these compounds. These classes of substances have proven to be suitable fluorescent components according to the invention, in particular the optical brighteners, such as in particular the class of stilbenes. But also inorganic fluorescent compounds, such as calcium fluoride, have proven to be particularly suitable due to their high stability, in particular stability of fluorescence.

In a (preferred) exemplary embodiment, the fluorescent component further comprises a heteroaromatic compound having at least two rings, in particular an indole compound. Tryptophan—an aromatic amino acid having an indole ring structure—has proven to be particularly suitable. The inventors have found that, by a combination of a fluorescent component with such a heteroaromatic compound, a significant increase in the emission of the fluorescent component may be achieved, in particular in the UVA range and thus in the light spectrum perceptible to birds, but not to humans, thereby significantly increasing the effectivity of a thus provided structural element in the avoidance of bird strike without impairing its appearance for the human eye.

In an (also preferred) exemplary embodiment, the fluorescent area is at least partly primed (undercoated) with a layer comprising or consisting of a polymer. In other words, it may be preferred if there is a layer comprising or consisting of a polymer between at least a part of the fluorescent area and of the transparent base body. The inventors have found that, by priming the fluorescent area, i.e. the area where the fluorescent component is arranged, with a polymer layer, a significant increase in the emission of the fluorescent component may be achieved, in particular in the UVA range and thus in the light spectrum perceptible to birds, but not to humans, thereby significantly increasing the effectivity of a thus provided structural element in the avoidance of bird strike without impairing its appearance for the human eye. Suitable examples for the polymer include polyvinyl alcohol (PVA), polyvinyl pyrrolidone (PVP) and polyethylene imine (PEI). Among them, polyvinyl alcohol (PVA) has proven to be particularly suitable.

It may be particularly advantageous to combine the fluorescent component with a heteroaromatic compound having at least two rings and to prime or undercoat the fluorescent area with a layer comprising or consisting of a polymer. In particular, a priming of the fluorescent area with a layer containing PVA combined with a blending of tryptophan to the fluorescent component may result in a synergistically particularly effective avoidance of bird strike.

In an exemplary embodiment, the component reflecting UVA light comprises inorganic microparticles (fine-grained inorganic substances). In particular, titanium dioxide has proven to be suitable for this purpose.

In this connection, it should be noted that some substances may exhibit both UVA light-absorbing and florescent properties (for instance polyphenols and flavonoids) and some substances may exhibit both UVA light-absorbing and

UVA light-reflecting properties (for instance inorganic microparticles) and may thus be used as a component absorbing UVA light as well as a fluorescent component or as a component absorbing UVA light as well as component reflecting UVA light. For solving the objection of the invention, it is decisive that the structural element comprises components absorbing UVA light, fluorescent components as well as components reflecting UVA light, irrespective of whether this is realized or implemented by means of one, two, three or more different substances.

In an exemplary embodiment, the UVA light-absorbing area, the fluorescent area and/or the UVA light-reflecting area further comprise at least one stabilizer, for instance a stabilizer that increases the heat resistance of the in particular organic dyes (such as during processing) and/or a stabilizer that stabilizes the fluorescence of the fluorescent component. A suitable stabilizer that increases the heat resistance of the organic dyes during processing has proven to be in particular adamantane. But also other additives may be suitable for this purpose. For stabilizing the fluorescence of the fluorescent component, stabilizers, additives and/or microparticles may be used.

In a further exemplary embodiment, the UVA light-reflecting area comprises a multilayer coating containing at least two layers having a different index of refraction (refractive index). By taking this measure, optical effects may be generated that are particularly well perceptible to birds and that may thus contribute to an efficient avoidance of bird strike. In addition, such a multilayer coating may be easily applied by means of foils or varnishes on a transparent base body.

In an exemplary embodiment, the UVA light-absorbing area, the fluorescent area, the UVA light-reflecting area and/or a transparent area form a pattern on the transparent base body. For instance, the UVA light-absorbing area, the fluorescent area, the UVA light-reflecting area and/or a transparent area may be shaped as strips or bands (for instance having a width between 1 cm and 5 cm), circles (for instance having a diameter between 1 cm and 5 cm), spots or with irregular shape. By taking this measure, the visual stimulus for birds may be increased in a simple manner and a high-contrast picture or visualization may be generated so that the thus provided structural element can be better and faster recognized by birds also while flying.

It is also possible that the UVA light-absorbing area, the fluorescent area, the UVA light-reflecting area and/or a transparent area are arranged or formed such that a certain motif, such as a pattern or figures, may be generated that is perceptible to birds as an obstacle. Due to the different optical effects, which may be generated by the different components and their respective areas, more realistic motifs may be generated which can thus be more clearly recognized by birds as an obstacle than for instance black silhouettes of birds of prey conventionally applied to a window, the efficiency of which in the avoidance of bird strike is disputed, if not even disapproved, among experts.

The variety of possible combinations of components absorbing UVA light, fluorescent components and components reflecting UVA light or their corresponding areas, as only exemplarily indicated in the foregoing, provide for a myriad of design possibilities for the avoidance of bird strike so that both tailored solutions (for instance adapted with regard to specific bird species and/or taking architectural requirements into account) and universally applicable measures for the protection of birds may be realized in an efficient and simple manner.

A production method according to the present invention, i.e. a process for producing a structural element, in particular a structural element according to the invention as described herein, comprises the following steps:
providing a transparent base body, in particular made of glass and/or a transparent plastic material,
applying a component absorbing UVA light on at least a part of a surface of the transparent base body,
applying a fluorescent component on at least a part of a surface of the transparent base body,
applying a component reflecting UVA light on at least a part of a surface of the transparent base body.

By means of the production method according to the invention, a structural element according to the invention may be directly produced in a simple manner. In particular, the components, materials or substances as mentioned above in connection with the structural element may be utilized in the production method.

In an exemplary embodiment, the component absorbing UVA light, the fluorescent component and/or the component reflecting UVA light are applied side by side on a surface of the transparent base body. In particular, the components may be applied directly adjacent to each other and/or spaced apart from each other, for instance spaced apart from each other by a transparent area.

In an exemplary embodiment, the component absorbing UVA light, the fluorescent component and/or the component reflecting UVA light are applied at least partly overlapping or at least partly superposed.

In an exemplary embodiment, the component absorbing UVA light, the fluorescent component and/or the component reflecting UVA light are applied in a (single) process step, which may enable a particular efficient and economic production. It may however also be possible to apply the component absorbing UVA light, the fluorescent component and/or the component reflecting UVA light in two, three or more (in particular sequential) process steps, in particular if the different components require different application techniques or if by means of different application techniques additional optical effects perceptible to birds are to be achieved.

In an exemplary embodiment, the component absorbing UVA light, the fluorescent component and/or the component reflecting UVA light are applied (in particular directly) on the respective part of the surface of the transparent base body. For instance, the component absorbing UVA light, the fluorescent component and/or the component reflecting UVA light may be applied by means of a printing method (e.g. screen printing or ink jet printing), a spraying method (e.g. airbrush) or a chemical or physical deposition method (e.g. by means of chemical vapor deposition, physical vapor deposition, sputtering).

In particular, a printing method, such as in particular screen printing or ink jet printing, has proven to be particularly suitable for the generation of certain (regular) patterns or motifs on the transparent base body and a spraying method, such as in particular airbrush, may be suitable for the generation of more irregular, chaotic or random patterns. For both printing methods and spraying methods, which may be particular suitable for the application of organic components, it may be advantageous if the surface of the transparent base body has been primed or undercoated prior to the application, for instance by applying a prime coat (e.g. of a polymer), which may not only improve the optical properties, in particular in case of a fluorescent component, but may also improve the adhesion of the applied components on the transparent base body and may thus improve their durability, in particular their weather resistance.

But also chemical or physical deposition methods, such as in particular sputtering, have proven to be suitable, in particular for the application of inorganic microparticles (e.g. TiO₂). In this case, it may also be possible to carry out a subsequent sintering. In doing so, it may be advantageous that other components, in particular organic components, that may be destroyed at high temperatures, are applied after sintering.

If the transparent base body is composed of several layers or panes, such as in case of a laminated or multilayer glass, it may also be possible to arrange or embed the component absorbing UVA light, the fluorescent component and/or the component reflecting UVA light between two layers or panes of the transparent base body. By taking this measure, a good weather resistance may in particular be achieved.

It is also possible to cover the UVA light-absorbing, fluorescent and/or UVA light-reflecting areas with a (thin) glass layer of chemically toughened or prestressed glass so as to improve their weather resistance.

In an embodiment, the component absorbing UVA light, the fluorescent component and/or the component reflecting UVA light may also be incorporated or integrated within the material of the transparent base body, such as glass or a transparent plastic material, for instance already blended to the raw material during the production of the transparent base body. In this regard, it may be advantageous, in particular when incorporating organic dyes, to additionally incorporate a stabilizer increasing the heat resistance of in particular organic dyes during processing.

In an embodiment, the component absorbing UVA light, the fluorescent component and/or the component reflecting UVA light are applied by means of a foil (film, sheet). For instance, the component absorbing UVA light, the fluorescent component and/or the component reflecting UVA light may be added to the material for extrusion in the production of foils and thereby incorporated or integrated within in the foil, or printed (e.g. by means of screen printing or ink jet technology) or deposited on the foil. It may also be possible to emboss a microstructure in the foil, for instance by means of a roll, which may in particular be suitable for generating a component reflecting UVA light. In this regard, it may be preferable, in particular when adding organic dyes to a material for extrusion, to additionally blend a stabilizer increasing the heat resistance of in particular organic dyes during processing to the material for extrusion.

It is also possible to embed the component absorbing UVA light, the fluorescent component and/or the component reflecting UVA light between two foils, for instance by applying a foil and covering, for instance by means of laminating, the UVA light-absorbing, fluorescent and/or UVA light-reflecting areas with a further foil. By taking this measure, a good weather resistance may in particular be achieved.

Multiple foils containing for instance different components may also be cut into strips and subsequently laminated together or applied sided by side or also partly overlapping on a transparent base body.

In an embodiment, the component absorbing UVA light, the fluorescent component and/or the component reflecting UVA light are applied as a varnish comprising the component absorbing UVA light, the fluorescent component and/or the component reflecting UVA light. In the context of the present application, the term “varnish”, which may also be referred to as a “paint” or as a “lacquer”, may in particular denote a in particular a liquid or powdery composition that may be applied on a transparent base body and becomes a solid film by means of chemical or physical processes (such as by evaporation of a solid or curing of a binder). To this end, the varnish may further comprise a binder, such as a resin, a solvent and/or further additives in addition to a component absorbing UVA light, a fluorescent component and/or a component reflecting UVA light. For instance, the varnish may be applied by spraying (such as by means of airbrush), rolling, wiping or (in particular uniform) spreading or distributing by means of a cloth or squeegee on the transparent base body. A desired pattern (e.g. an irregular or chaotic pattern) may be obtained for instance by a phase separation.

It is also possible to incorporate or embed such a varnish between two foils, between two layers or panes in case of a multilayer transparent base body or between a foil and the transparent base body, which may result in a particularly good weather resistance.

In an embodiment, prior to the application of the fluorescent component, a layer comprising or consisting of a polymer, in particular polyvinyl alcohol, is formed at least partly at that part of the transparent base body, where subsequently the fluorescent component is applied. Such a priming, in particular of the fluorescent area, may—as mentioned above—not only improve the optical properties, in particular in case of a fluorescent component, but may also improve the adhesion of the applied components on the transparent base body. Therefore, it may be advantageous if also other areas, in particular also the UVA light-absorbing area and/or der UVA light-reflecting area are primed by means of a polymer layer.

The present invention is further described by reference to the accompanying figures, which are solely for the purpose of illustrating specific embodiments and shall not be construed as limiting the scope of the invention in any way. The illustrations in the drawings are schematic and are not necessarily drawn to scale. Same or similar elements in different figures are denoted with the same with the same reference signs.

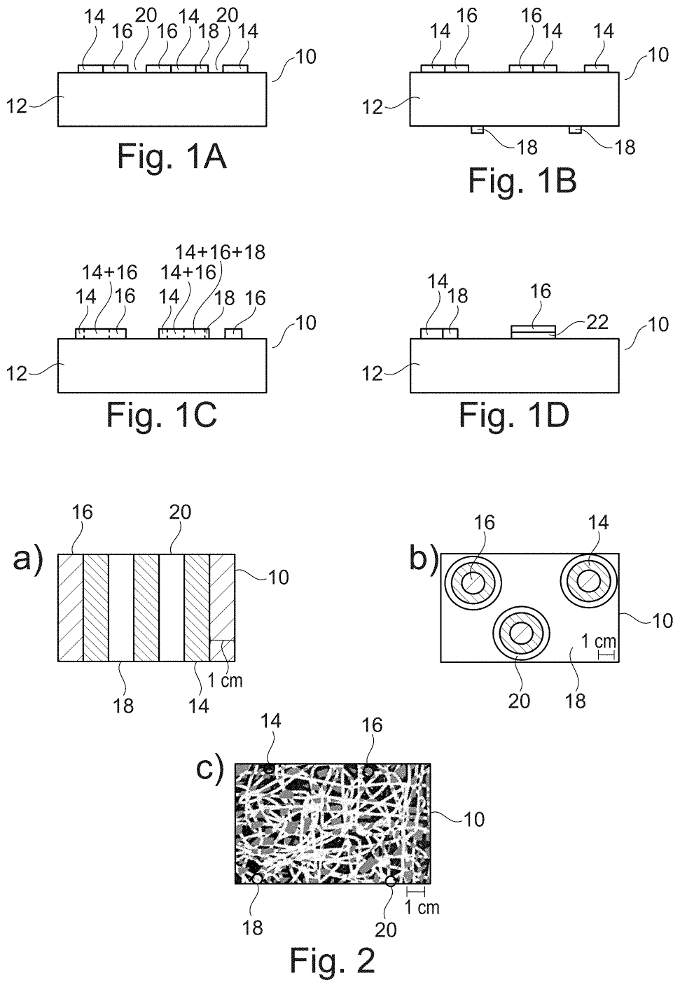

FIG. 1 shows lateral cross-sectional views of structural elements according to various embodiments of the invention. In detail, four different embodiments or variants of arrangements of UVA light-absorbing areas 14, fluorescent areas 16 and UVA light-reflecting areas 18 are described in FIG. 1A to 1D, which embodiments or variants may however all be combined with each other.

FIG. 1A shows a structural element 10 according to an exemplary embodiment having a transparent base body 12, wherein UVA light-absorbing areas 14, fluorescent areas 16 and UVA light-reflecting areas 18 are all arranged on one surface or side of the transparent base body 12. In addition, this surface further comprises transparent areas 20. The UVA light-absorbing areas 14, the fluorescent areas 16 and the UVA light-reflecting areas 18 are arranged side by side in the shown embodiment, some are arranged directly adjacent, while some are arranged spaced apart from another thereby forming transparent areas 20. By taking this measure, a particular high-contrast appearance for birds may be evoked so that they can better perceive the structural element 10 as an obstacle.

FIG. 1B shows a structural element 10 according to an exemplary embodiment having a transparent base body 12, wherein in contrast to the embodiment shown in FIG. 1A, the UVA light-absorbing areas 14, fluorescent areas 16 and UVA light-reflecting areas 18 are not all arranged on one surface or side of the transparent base body 12. Rather, in the shown embodiment, the UVA light-reflecting areas 18 are arranged on the opposing side or surface of the transparent base body 12 relative to the UVA light-absorbing areas 14 and the fluorescent areas 16. It will be understood by a person skilled in the art that in other embodiments also fluorescent areas 16 or UVA light-absorbing areas 14 may be arranged on one side of the transparent base body 12 and the respective other two types of components are arranged at the opposing side of the transparent base body 12. Alternatively, it is also possible to arrange components of the same type on both opposing surfaces. The UVA light-absorbing areas 14 and the fluorescent areas 16 are arranged side by side in the shown embodiment, in part arranged directly adjacent, but also in part spaced apart from another. Even though the UVA light-absorbing areas 14, the fluorescent areas 16 and the UVA light-reflecting areas 18 are arranged in an offset manner in the shown embodiment so that incident light to the structural element 10 vertically from above or below passes or hits only one of the UVA light-absorbing areas 14, the fluorescent areas 16 and the UVA light-reflecting areas 18, in other embodiments the UVA light-absorbing areas 14, the fluorescent areas 16 and/or the UVA light-reflecting areas 18 may also be arranged on opposing sides of the transparent base body 12 partly opposite (i.e. not offset) so that incident light to the structural element 10 vertically from above or below may pass or hit for instance both a fluorescent area 16 as well as on the opposing side a UVA light-reflecting area 18 and may thus generate additional optical effects evoked by a combination of—in this particular case—fluorescence and reflection, further increasing the perceptibility of the structural element 10 to birds.

FIG. 1C shows a structural element 10 according to an exemplary embodiment having a transparent base body 12, wherein UVA light-absorbing areas 14, fluorescent areas 16 and UVA light-reflecting areas 18 are all arranged on one surface or side of the transparent base body 12, but in contrast to the embodiment shown in FIG. 1A some of the UVA light-absorbing areas 14, the fluorescent areas 16 and the UVA light-reflecting areas 18 partly overlap, which is indicated by dashed lines and combined reference signs (such as 14+16 or 14+16+18) in FIG. 1C. By an overlap of the areas, additional optical effects may be generated, which may be evoked by a combination of the concerned components and which may further increase the perceptibility of the structural element 10 to birds.

FIG. 1D shows a structural element 10 according to an exemplary embodiment having a transparent base body 12, wherein UVA light-absorbing areas 14, fluorescent areas 16 and UVA light-reflecting areas 18 are all arranged on one surface or side of the transparent base body 12, as in the embodiment shown in FIG. 1A. In addition to the embodiment shown in FIG. 1A, there is however, between the fluorescent area 16 and the transparent base body 12, a primer coat 22 which may be formed of a polymer and significantly increases both the adhesion of the fluorescent area 16 at the transparent base body 12 and in particular also the emissivity of the fluorescent component in the fluorescent area 16.

FIG. 2 shows plan views of structural elements according to various embodiments of the invention. In detail, three different patterns that may be formed by UVA light-absorbing areas 14, fluorescent areas 16 and UVA light-reflecting areas 18 are described in FIG. 2A to 2C, which patterns may however all be combined with each other.

FIG. 2A shows a stripe pattern, wherein UVA light-absorbing areas 14, fluorescent areas 16, UVA light-reflecting areas 18 and transparent areas 20 are arranged side by side in the shape of strips. The individual strips may for instance have a width between 1 and 5 cm. The stripe pattern shown in FIG. 2A may for instance be generated by means of screen printing or ink jet printing, wherein it may be advantageous if the subjacent transparent base body (not shown) already comprise an optical component exhibiting for instance transparency or reflection in the UVA range. The stripe pattern shown in FIG. 2A may for instance also be generated by means of a laminating technique by joining several foils having the respective optical properties.

FIG. 2B shows a circle or spot pattern, wherein UVA light-absorbing areas 14, fluorescent areas 16 and transparent areas 20 are arranged in the shape of concentric circles (for instance having a diameter between 1 cm and 5 cm). Besides the circles, further areas are configured as UVA light-reflecting areas 18. Like the stripe pattern shown in FIG. 2A, also the circle or spot pattern shown in FIG. 2B may for instance be generated by means of screen printing or ink jet printing, wherein it may also be advantageous if the subjacent transparent base body (not shown) already comprises an optical component, for instance exhibiting reflection in the UVA range in the embodiment shown in FIG. 2B.

FIG. 2C shows an irregular or chaotic pattern, wherein UVA light-absorbing areas 14, fluorescent areas 16, UVA light-reflecting areas 18 and transparent areas 20 are arranged in an irregular manner side by side as well as partly overlapping. Such an irregular or chaotic pattern may for instance be generated by means of phase separation by applying a dispersion of a varnish layer (for instance by spraying, wiping or rolling). Alternatively, it may also be possible to superpose and laminate several foils having different optical properties.

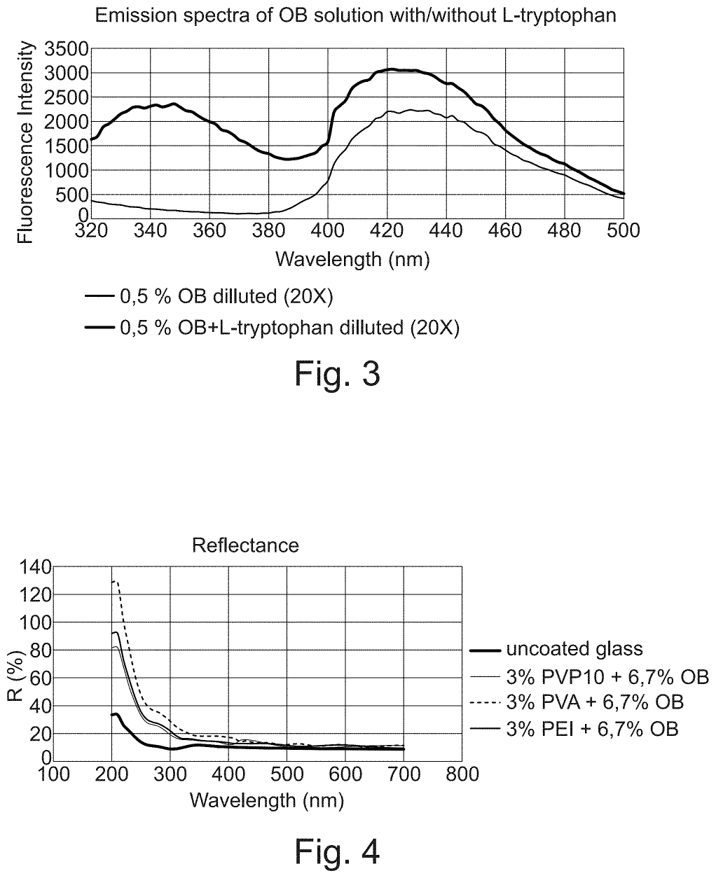

FIG. 3 shows emission spectra of an optical brightener in the presence or absence of tryptophan. The lower one of the two graphs as shown represents an emission spectrum of an optical brightener in a concentration of 0.5% in the absence of tryptophan. The upper one of the two graphs as shown represents an emission spectrum of the same optical brightener in a concentration of 0.5%, but this time in the presence of tryptophan in a concentration of 0.5%, too. As can be taken from the two emission spectra, by blending of an indole compound, such as tryptophan, to a fluorescent component, such as an optical brightener, the emissivity in particular in the UVA range of about 320 to 400 nm, which is not perceptible to humans, but perceptible to birds, may be drastically increased so that the effectivity of a structural element provided with such a blend in the avoidance of bird strike may be significantly increased without impairing its appearance for the human eye.

FIG. 4 shows results of a reflection determination of an optical brightener without prime coats and with different prime coats. The reflection determination is in this connection indicative for the emitted light and thus for the emissivity of the fluorescence. Blankophor P01 from Indulor was used as an optical brightener. In FIG. 4, there is shown the reflectivity (reflectance) of uncoated glass (lowermost graph) as well as of 6.7% of the optical brightener (OB), applied on a glass plate coated or primed with 3% polyvinyl pyrrolidone (PVP) (second lowermost graph), with 3% polyethylene imine (PEI) (second uppermost graph) or with 3% polyvinyl alcohol (PVA) (uppermost graph), respectively. As can be taken from the results shown in FIG. 4, by priming with a polymer layer, the emissivity of a fluorescent component, such as an optical brightener, in the UV range (i.e. below 400 nm) may be drastically increased, also in the UVA range of about 320 to 400 nm, which is not perceptible to humans, but perceptible to birds, so that by such a prime coat, in particular when using polyvinyl alcohol (PVA), the effectivity of a structural element thus provided in the avoidance of bird strike may be significantly increased without impairing its appearance for the human eye.

While the present invention has been described in detail by way of specific embodiments and examples, the invention is not limited thereto and various alterations and modifications are possible, without departing from the scope of the invention. It should be noted that reference signs in the claims shall not be construed as limiting the scope of the claims.

### LIST OF REFERENCE SIGNS

10 structural element
12 transparent base body
14 UVA light-absorbing area
16 fluorescent area
18 UVA light-reflecting area
20 transparent area
22 prime coat

1. A structural element (10), in particular a pane element, having a transparent base body (12), in particular made of glass and/or a transparent plastic material, wherein the transparent base body (12) is at least partly covered with a component absorbing UVA light, at least partly covered with a fluorescent component and at least partly covered with a component reflecting UVA light.

2. The structural element (10) according to claim 1, wherein a surface of the transparent base body (12) is at least partly covered with a component absorbing UVA light, at least partly covered with a fluorescent component and at least partly covered with a component reflecting UVA light.

3. The structural element (10) according to claim 1, wherein the component absorbing UVA light is arranged in a UVA light-absorbing area (14), the fluorescent component is arranged in a fluorescent area (16) and the component reflecting UVA light is arranged in a UVA light-reflecting area (18).

4. The structural element (10) according to claim 3, wherein at least two, in particular all three, of the UVA light-absorbing area (14), the fluorescent area (16) and the UVA light-reflecting area (18) are arranged side by side.

5. The structural element (10) according to claim 3, wherein at least two, in particular all three, of the UVA light-absorbing area (14), the fluorescent area (16) and the UVA light-reflecting area (18) at least partly overlap.

6. The structural element (10) according to claim 1, wherein the component absorbing UVA light is selected from the group consisting of aromatic CH-acidic diketones, aromatic ketones, 6,7-dihydroxycoumarins, polyphenols, flavonoids, inorganic microparticles and mixtures thereof.

7. The structural element (10) according to claim 1, wherein the component absorbing UVA light is selected from the group consisting of avobenzone, benzophenone, aesculin, quercetin, rutin and mixtures thereof.

8. The structural element (10) according to claim 1, wherein the fluorescent component is selected from the group consisting of optical brighteners, in particular stilbenes, polyphenols, flavonoids, inorganic fluorescent compounds and mixtures thereof.

9. The structural element (10) according to claim 8, wherein the fluorescent component further comprises a heteroaromatic compound having at least two rings, in particular an indole compound.

10. The structural element (10) according to claim 3, wherein the fluorescent area (16) is at least partly primed with a layer (22) comprising or consisting of a polymer, in particular polyvinyl alcohol.

11. The structural element (10) according to claim 1, wherein the component reflecting UVA light comprises inorganic microparticles, in particular titanium dioxide.

12. The structural element (10) according to claim 3, wherein the UVA light-reflecting area (18) comprises a multilayer coating containing at least two layers having a different index of refraction.

13. The structural element (10) according to claim 3, wherein the UVA light-absorbing area (14), the fluorescent area (16), the UVA light-reflecting area (18) and/or a transparent area (22) form a pattern on the transparent base body (12).

14. A process for producing a structural element (10), in particular a structural element (10) according to claim 1, wherein the process comprises the following steps:
providing a transparent base body (12), in particular made of glass and/or a transparent plastic material,
applying a component absorbing UVA light on at least a part of a surface of the transparent base body (12),
applying a fluorescent component on at least a part of a surface of the transparent base body (12),
applying a component reflecting UVA light on at least a part of a surface of the transparent base body (12).

15. The process for producing a structural element (10) according to claim 14, wherein the component absorbing UVA light, the fluorescent component and/or the component reflecting UVA light are applied side by side on a surface of the transparent base body (12).

16. The process for producing a structural element (10) according to claim 14, wherein the component absorbing UVA light, the fluorescent component and/or the component reflecting UVA light are applied at least partly overlapping.

17. The process for producing a structural element (10) according to claim 14, wherein the component absorbing UVA light, the fluorescent component and/or the component reflecting UVA light are applied on the respective part of the surface of the transparent base body (12).

18. The process for producing a structural element (10) according to claim 14, wherein the component absorbing UVA light, the fluorescent component and/or the component reflecting UVA light are applied by means of a foil.

19. The process for producing a structural element (10) according to claim 14, wherein the component absorbing UVA light, the fluorescent component and/or the component reflecting UVA light are applied as a varnish comprising the component absorbing UVA light, the fluorescent component and/or the component reflecting UVA light.

20. The process for producing a structural element (10) according to claim 14, wherein, prior to applying the fluorescent component, a layer (22) comprising or consisting of a polymer, in particular polyvinyl alcohol, is formed at least partly at that part of the transparent base body (12) where subsequently the fluorescent component is applied.
